(19) United States
(12) Patent Application Publication
(10) Pub. No.: US 2006/0253643 A1
(43) Pub. Date: Nov. 9, 2006

(54) Memory with isolated master boot record

(75) Inventor: Arthur G. Blanck, Ramona, CA (US)

Correspondence Address: PETER K HAHN;LUCE, FORWARD, HAMILTON, SCRIPPS, LLP., 600 WEST BROADWAY, SUITE 2600, SAN DIEGO, CA, 92101, US

(73) Assignee: Delkin Devices, Inc.

(21) Appl. No.: 11/122,465

(22) Filed: May 4, 2005

(51) Int. Cl. G06F 12/00

(52) U.S. Cl. 711/103; 711/170

(57) ABSTRACT

The present invention provides a nonvolatile flash memory comprising a data storage space having a first erase block and an active partition, wherein the first erase block comprises an MBR. The active partition comprises a boot sector followed by a master FAT, a backup FAT and a root directory. The first erase block is disposed outside of the active partition such that the flash memory remains operable even if the boot sector and FAT become corrupted.

### FIELD OF THE INVENTION

The present invention is directed to a nonvolatile memory having an isolated master boot record.

### BACKGROUND OF THE INVENTION

Flash based memory cards are solid state, removable mass storage devices for electronic equipment. Conventional flash memory cards employ partitioning and formatting methodologies of the hard disk drive (HDD) industry. Such cards require a master boot record (MBR) at the beginning of the storage space in order to be recognizable by a host. The MBR contains a bootstrap loader program for starting the memory card and a partition table that describes the number of partitions as well as their size and location within the memory card.

Memory card files and data generally are arranged and accessed using methods that enhance storage space and increase data access efficiency. One current method employed in many digital appliances involves the use of a file allocation table (FAT) system. In a FAT based system, partitions are formatted with a boot sector comprising one or two sectors, which is followed by a master FAT, which is followed by a backup FAT, which is followed by a root directory.

Each FAT comprises one or more contiguous locations, typically 12, 16 or 32 bits in length, that are used to represent larger data areas or clusters within the root directory. Each cluster generally comprises 1 to 128 sectors and is represented by the same FAT entry. The FATs must be updated every time a file or directory is created, modified or deleted in order to properly represent the state of the associated cluster

In general, flash memory is broken down into a plurality of blocks. Each block comprises a plurality of pages and each page comprises one or more erase blocks. The first erase block of a conventional flash memory includes the MBR, the boot sector and the master FAT. Problems may arise during certain circumstances such as when power to the memory card is shut down while the master FAT is being updated. In this case, the first erase block may be corrupted since data is not completely written to the erase block. If the MBR is incomplete, the entire memory card becomes inoperable.

In view of the above, there exists a need for an improved flash memory having an isolated MBR.

### SUMMARY OF THE INVENTION

The present invention provides an improved flash memory having an isolated MBR. In particular, the invention is directed to isolating the MBR in its own erase block outside of the active partition, wherein the boot sector and master FAT are provided in a separate erase block within the active partition. If a problem occurs that corrupts the boot sector or master FAT, the MBR remains uncorrupted and the card operable.

One aspect of the present invention involves a nonvolatile flash memory comprising a data storage space having a first erase block and an active partition, wherein the first erase block comprises an isolated and uncorruptable MBR. The active partition comprises a boot sector followed by a master FAT, a backup FAT and a root directory. The first erase block is disposed outside of the active partition such that the flash memory remains operable even if the boot sector and FAT become corrupted. When the flash memory is operable, it may be booted and reformatted.

According to a preferred implementation of the invention, the boot sector and master FAT are provided in a separate erase block within the active partition. As such, all active and non-active partitions are located outside of the first erase block such that the MBR will not become unintentionally corrupted by a host during normal memory operation. As a result, the MBR remains uncorrupted in the event of a power spike or a power off occurs. Consequently, the flash memory remains operable in the event of a power spike or a power off.

These and other features and advantages of the present invention will be appreciated from review of the following detailed description of the invention, along with the accompanying figures in which like reference numerals refer to like parts throughout.

### BRIEF DESCRIPTION OF THE DRAWINGS

FIG. 1 (prior art) is a schematic of a conventional flash memory chip;

FIG. 2 (prior art) is a schematic of a portion of the data storage space a conventional flash memory;

FIG. 3 is a block diagram of a flash memory card in accordance with the principles of the present invention;

FIG. 4 is a block diagram of the nonvolatile flash memory of the flash memory card of FIG. 3; and

FIG. 5 is a schematic of a portion of the data storage space of a nonvolatile memory in accordance with the principles of the present invention.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

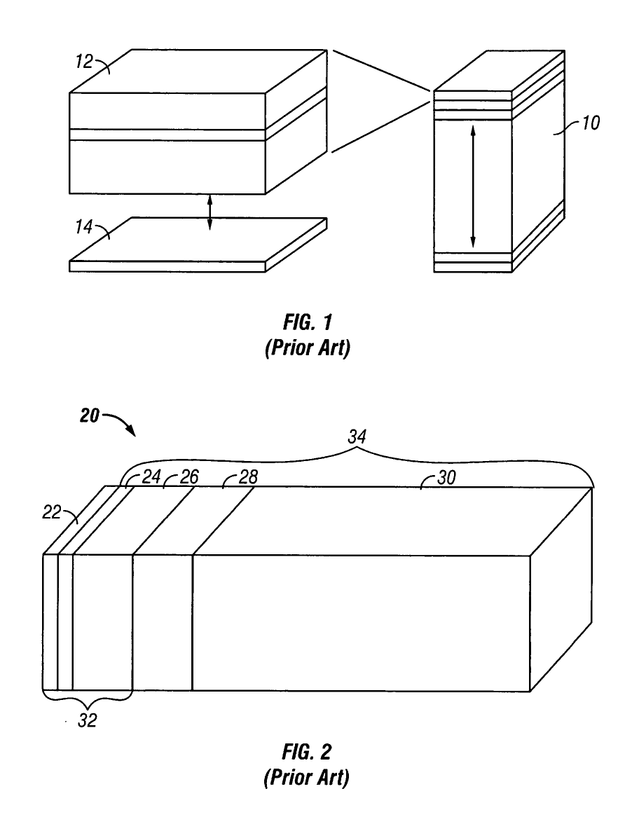

Referring to FIG. 1 (prior art), conventional flash memory chip 10 comprises erase blocks 12, wherein each erase block 12 comprises 32 to 64 programming pages 14. Programming pages 14 are 512 to 2048 bytes in length. Once a page 14 has been programmed, it must be erased before it is capable of being re-programmed. To re-program a page within an erase block, all of the pages within the erase block are read out, the block is erased, and all of the pages are re-programmed. If this process is interrupted before all of the pages are re-programmed, the data will be lost or corrupted.

FIG. 2 (prior art) is a schematic of a portion 20 of the data storage space of a conventional flash memory. Portion 20 comprises MBR 22 followed by boot sector 24, master FAT 26, backup FAT 28 and root directory 30. Included in the MBR is data which identifies the beginning location and the location of other partitions on the disk. First erase block 32 of the flash memory comprises MBR 22, boot sector 24 and master FAT 26, whereas active partition 34 comprises boot sector 24, master FAT 26, backup FAT 28 and root directory 30. As described hereinabove, first erase block 32 may become corrupted if problems such as power outages or surges arise while master FAT 26 is in the process of being updated. Under these circumstances, data is not completely written to first erase block 32, thereby rendering the memory card inoperable.

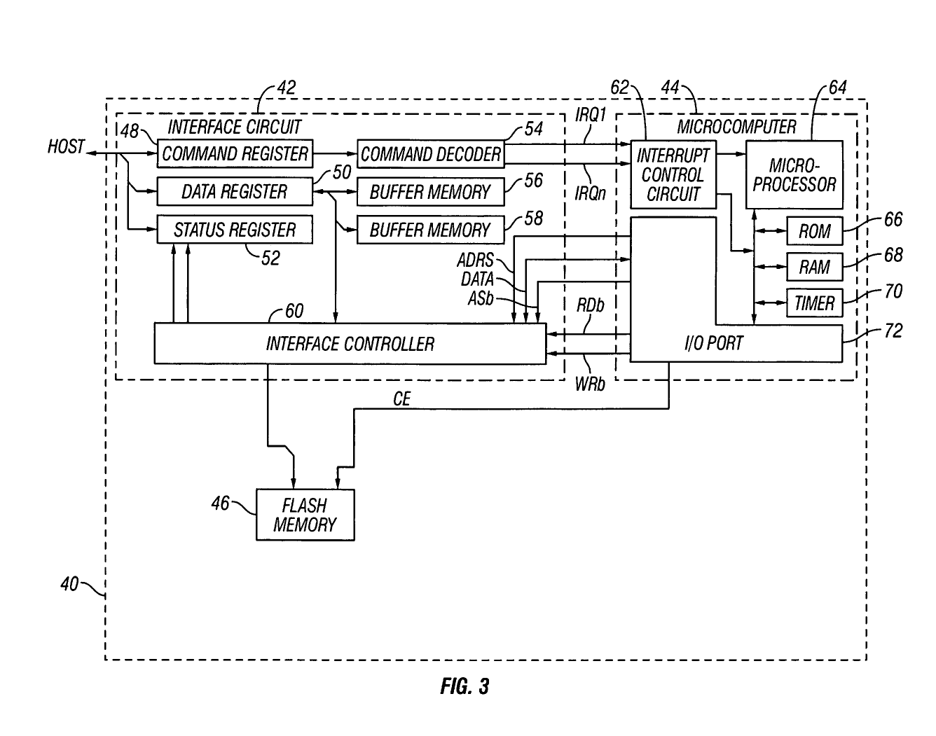

Referring to FIG. 3, flash memory card 40 of the present invention comprises interface circuit 42, microcomputer 44 and nonvolatile flash memory 46, which are mounted on a printed circuit board. Interface circuit 42 and microcomputer 44 constitute a controller. Flash memory card 40 is configured to be inserted into the PC card slot of a host such as a personal computer. Interface circuit 42 includes command register 48, data register 50, status register 52, command decoder 54, buffer memories 56, 58 and interface controller 60.

Microcomputer 44 comprises interrupt control circuit 62, microprocessor 64, ROM (Read Only Memory) 66, RAM (Random Access Memory) 68, timer 70, and input/output port 72. Interface circuit 42 is linked through the PC card slot to the host, which gives a file operation command to command register 485 and it is decoded by command decoder 54. Command decoder 54 releases interrupt signals IRQ1-IRQn depending on the decoding result. Interrupt control circuit 62 gives the interrupt signals IRQ1-IRQn to microprocessor 64. ROM 66 stores an operation program of microprocessor 64, which runs the program by using RAM 68 for the work area.

Microcomputer 44 controls interface circuit 42 and flash memory 46 through input/output port 72 in accordance with the operation program. Microcomputer 44 releases the address signal ADRS, address strobe signal ASb, read signal RDb and write signal WRb to interface controller 60 to transact data (DATA) with it. Microcomputer 44 accesses data register 50, status register 52 and buffer memories 56, 58 through interface controller 60. The flash memory 46 shares the control signal lines and data signal lines which are connected to the interface controller 60. Microcomputer 44 releases the chip enable signals CE of individual chips of flash memory 46 from input/output port 72. Based on this arrangement, microcomputer 44 selects a chip of flash memory 46 and releases an address signal ADRS, address strobe signal ASb, read signal RDb and write signal WRb to interface controller 60, thereby making access to the selected chip of flash memory 46 by way of interface controller 60.

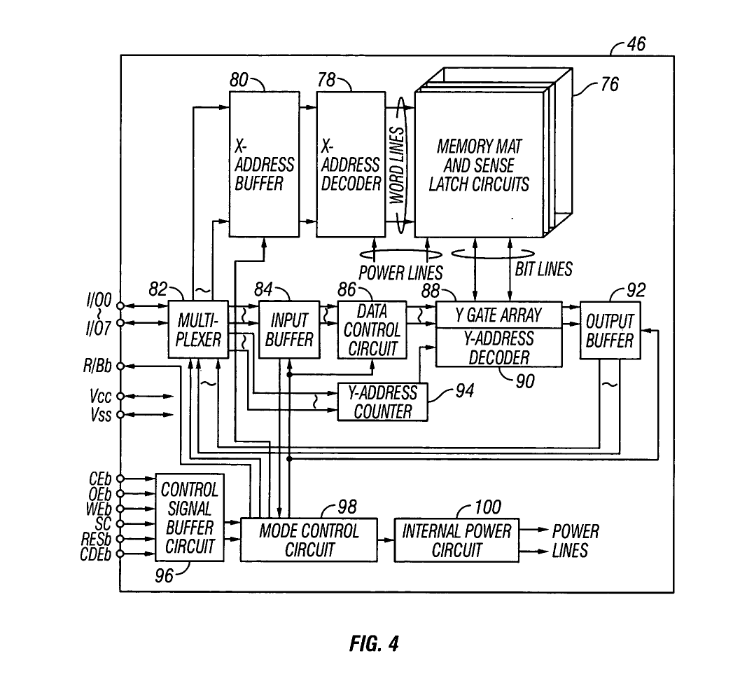

Referring to FIG. 4, flash memory 46 comprises memory array 76, x-address decoder 78, x-address buffer 80, multiplexer 82, input buffer 84, data control circuit 86, y gate array 88, y-address decoder 90, output buffer 92, y-address counter 94, control signal buffer circuit 96, mode control circuit 98, and internal power circuit 100. Memory array 76 comprises a memory mat and sense-latch circuit, wherein the memory mat has numerous memory cells of transistors which are nonvolatile and electrically erasable and rewritable.

Input/output terminals I/O0-I/O7 are used for the address input terminals, data input terminals and command input terminals. The x-address signal received on the input/output terminals I/O0-I/O7 is put in x-address buffer 80 via multiplexer 82. The x-address buffer releases internal complementary address signals, which are decoded by x-address decoder 78 to drive the word lines. The y-address decoder releases a select signal, based on which the y gate array selects bit lines. The y-address signal received on the input/output terminals I/O0-I/O7 is preset to the y-address counter, which increments the contents and puts the resulting y-address signal in the y-address decoder.

Data control circuit 86 provides memory array 76 with data of logic values which are in accordance with the control of mode control circuit 98, besides the data received on the input/output terminals I/O0-I/O7. Control signal buffer circuit 96 receives external access control signals, which include a chip enable signal CEb, output enable signal OEb, write enable signal WEb, serial clock signal SC, reset signal RESb, and command enable signal CDEb. Mode control circuit 98 controls the flash memory interface function in accordance with these control signals and also controls the internal operation of flash memory 46 in accordance with the command. Internal power circuit 100 produces various power voltages used for memory writing, erase-verification and reading, and supplies these power voltages to the x-address decoder and memory cell arrays of the memory mats.

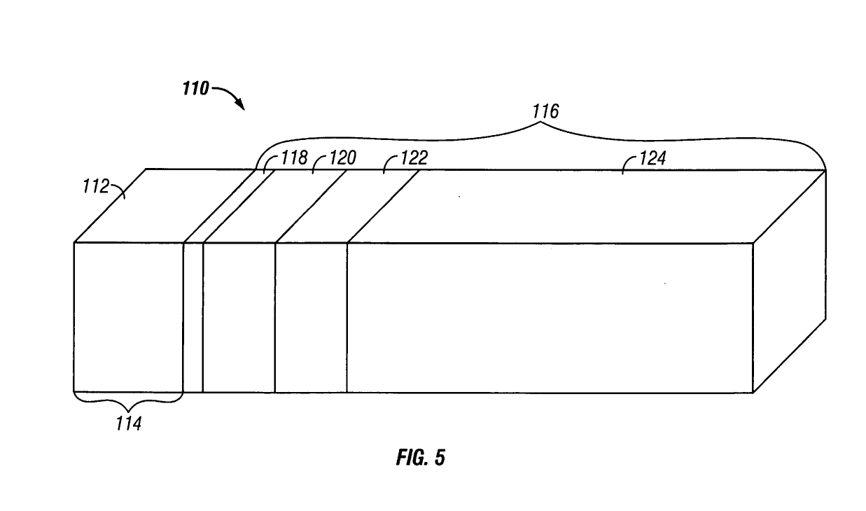

FIG. 5 is a schematic of the first portion 110 of the data storage space of a nonvolatile memory in accordance with the principles of the present invention. Advantageously, the data storage space features an isolated MBR 112 that is isolated in first erase block 114 outside of active partition 116. Active partition 116 comprises boot sector 118 followed by master FAT 120, backup FAT 122 and root directory 124. Boot sector 118 and master FAT 120 are provided in a separate erase block within the active partition 116. Consequently, if a power spike or power off occurs, MBR 112 is uncorrupted and the flash memory remains operable such that it may be booted and reformatted.

In accordance with the principles of the present invention, the improved flash memory is configured to have all partitions (active and non-active) located outside of the boundary of first erase block 114. By locating the partitions outside of first erase block 114 containing MBR 112, the MBR will not become unintentionally corrupted by the host during normal flash memory operation. When interleaving or writing to successive memory chips while the previously written to memory chips are busy, the partition offset is multiplied by the number of chips used in the interleaving process.

Thus, it is seen that a memory device having an isolated master boot record is provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

What is claimed is:

1. An electronic memory, comprising:
a data storage space comprising a first erase block;
wherein the first erase block consists of an MBR.

2. The electronic memory of claim 1, further comprising an active partition, wherein the first erase block is disposed outside of the active partition such that the MBR is isolated from the active partition.

3. The electronic memory of claim 2, wherein the active partition comprises a boot sector followed by a master FAT, a backup FAT and a root directory.

4. The electronic memory of claim 3, wherein the boot sector and master FAT are provided in a separate erase block within the active partition.

5. The electronic memory of claim 1, wherein the MBR is isolated in a portion of the memory that is not changed when data is saved to the memory.

6. The electronic memory of claim 1, wherein the memory remains operable in the event of a power spike or a power off.

7. The electronic memory of claim 3, wherein the MBR remains uncorrupted even if the boot sector and FAT become corrupted.

8. The electronic memory of claim 1, wherein all active and non-active partitions are isolated from the first erase block such that the MBR is not changed during normal memory operation.

9. A flash memory; comprising:
a data storage space comprising a first erase block and an active partition;
wherein the first erase block comprises an MBR;
wherein the active partition comprises a boot sector followed by a master FAT, a backup FAT and a root directory;
wherein the first erase block is disposed outside of the active partition; and
wherein the flash memory remains operable even if the boot sector and FAT become corrupted.

10. The flash memory of claim 9, wherein the boot sector and master FAT are provided in a separate erase block within the active partition.

11. The flash memory of claim 9, wherein the MBR remains operable in the event of a power spike or a power off occurs.

12. The flash memory of claim 9, wherein all active and non-active partitions are isolated from the first erase block such that the MBR is not changed during normal memory operation.

13. A memory, comprising:
a data storage space comprising a first portion and a second portion;
wherein the first portion includes a MBR and the second portion includes all data which may be modified during usage of the memory.

14. The memory of claim 13, wherein the first portion comprises a first erase block.

15. The memory of claim 14, wherein the second portion comprises an active partition.

16. The memory of claim 15, wherein the first erase block is disposed outside of the active partition such that the MBR is isolated from the active partition.

17. The memory of claim 15, wherein the active partition comprises a boot sector followed by a master FAT, a backup FAT and a root directory.

18. The memory of claim 13, wherein the MBR is isolated in a portion of the memory that is not changed when data is saved to the memory.

19. The memory of claim 13, wherein the memory remains operable in the event of a power spike or a power off.

20. A method of managing storage space of an electronic memory comprising the steps of:
dividing the storage space into a first portion and a second portion;
placing an MBR into the first portion;
placing all data which is modified when saving data in said memory in the second portion.
